(19) United States
(12) Patent Application Publication
(10) Pub. No.: US 2013/0047811 A1
(43) Pub. Date: Feb. 28, 2013

(54) MULTI-SLIT POWERED SLITTING MACHINE

(71) Applicants: T. Michael Shore, Princeton, MA (US); Kenneth Plante, Holden, MA (US); Richard Kowal, Spencer, MA (US)

(72) Inventors: T. Michael Shore, Princeton, MA (US); Kenneth Plante, Holden, MA (US); Richard Kowal, Spencer, MA (US)

(73) Assignee: SIEMENS INDUSTRY, INC., Alpharetta, GA (US)

(21) Appl. No.: 13/215,751

(22) Filed: Aug. 23, 2011

(51) Int. Cl. B26D 1/12

(52) U.S. Cl. 83/663

(57) ABSTRACT

An apparatus for slitting a hot rolled process section having parallel bars connected to together along at least one of their lengthwise edges, while the process section is moving longitudinally along a rolling line. The apparatus comprises first and second pairs of upper and lower rotatably driven slitting rollers positioned sequentially along the rolling line, with the slitting rollers of each pair being and arranged to engage opposite sides of the process section. The slitting rollers of the first pair have profiles configured to break the connection between at least some of the bars of the process section while allowing the connections between other bars of the process section to remain intact, and the slitting rollers of the second pair have profiles configured to break the remaining intact connections between the other bars of the process section.

### BACKGROUND

1. Field of the Invention

This invention relates to rolling mills in which billets are hot rolled into multi bar process sections that are then slit into individual bars, and is concerned in particular with the provision of an improved apparatus and method for slitting such process sections.

2. Description of Related Art

In conventional mill installations, it is known to roll heated billets into process sections comprised of multiple interconnected bars. The process sections are then pushed by the rolling action of a preceding roll stand through slitting guides having pairs of free wheeling slitting rollers configured to slit the process sections into individual bars. Experience has shown, however, that the force required to push the process sections through the slitting guides can distort and damage bar front ends, in addition to accelerating frictional wear of the slitting rollers. The resistance to the process section being pushed through the guides can also lead to unequal areas of the bars leaving the slitting guides. This force increases with larger process sections,

### SUMMARY

Briefly stated, exemplary embodiments of the present invention relate to an improved slitter having first and second pairs of upper and lower slitting rollers that are rotatably driven in directions urging the process section along the mill rolling line and through the slitter. The driving force of the slitting rollers eliminates the need to push the process section into and through the slitter, thus avoiding distortion and damage of the bar front ends, while also beneficially reducing frictional wear of the slitting rollers. The size of the rollers on the driven slitter can be larger than on a non-driven slitter, since there is no need to accelerate the rollers when the process section enters. This additionally results in longer life on the rollers, and improves slitting conditions by providing a larger bite angle.

Preferably, a gear drive mechanically couples the upper and tower slitting rollers of each pair to a single power source.

Advantageously, the upper and lower slitting rollers of each pair are carried respectively on upper and lower roller shafts, and the gear drive comprises an upper drive shaft carrying an upper drive gear in meshed relationship with driven gears on the upper roller shafts, and a lower drive shaft carrying a lower drive gear in meshed relationship with driven gears on the lower roller shafts, with the upper and lower drive gears being in meshed relationship, and with one of the drive shafts being connected to the single power source.

Advantageously, the spacing between the upper and lower roller shafts of at least one and preferably both of the first and second pairs is adjustable, and preferably such adjustments are performed symmetrically with respect to the rolling line.

Slitters in accordance with the present invention operate in two stages to slit process sections comprising four, five or six interconnected bars.

In one exemplary embodiment, the process section has four bars, the profiles of the first pair of slitting rollers are configured to separate the process section into two sets of two connected bars, and the profiles of the second pair of slitting rollers are configured to separate the bars of each of said sets.

In another exemplary embodiment, the process section has four bars, the profiles of the first pair of slitting rollers are configured to separate the outermost bars on each side of the process section from the two middle connected bars, and the profiles of the second pair of slitting rollers are configured to separate the two middle bars.

In stilt another exemplary embodiment, the process section has five bars, the profiles of the first pair of slitting rollers are configured to separate the middle bar from two outer sets of two connected bars, and the profiles of the second pair of slitting rollers are configured to separate the two bars of the outer sets.

In another exemplary embodiment, the process section has six bars, the profiles of the first pair of slitting rollers are configured to separate the process section into three sets of two connected bars, and the profiles of the second pair of slitting rollers are configured to separate the bars of each set.

These and other embodiments, objects, features and advantages of the present invention will become more apparent upon reading the following specification in conjunction with the accompanying drawing figures.

### BRIEF DESCRIPTION OF THE DRAWINGS

FIG. 1 is a side view of a slitter in accordance with an exemplary embodiment of the present invention;

FIG. 2 is a top plan view of the slitter;

FIG. 3 is an end view of the slitter;

FIG. 4 is a longitudinal sectional view of the slitter take along line 4-4 of FIG. 3;

FIGS. 5 and 6 are cross sectional views taken respectively along lines 5-5 and 6-6 of FIG. 1,

FIG. 7 is a cross sectional view on an enlarged scale taken through the process section shown in FIG. 1; and

FIGS. 8A-8D are schematic illustrations of slitting processes that can be practiced with the present invention.

### DETAILED DESCRIPTION

To facilitate an understanding of embodiments, principles, and features of the present invention, they are explained hereinafter with reference to implementation in illustrative embodiments.

The components and materials described hereinafter as making up the various embodiments are intended to be illustrative and not restrictive. Many suitable components and materials that would perform the same or a similar function as the materials described herein are intended to be embraced within the scope of embodiments of the present invention.

As herein employed, the term “bars” is to be interpreted as including not only the rounds illustrated in the drawings, but also other bar products, including for example squares, hexes, angles and flats.

Referring now to the figures, wherein like reference numerals represent like parts throughout the views, embodiments of the present invention will be described in detail.

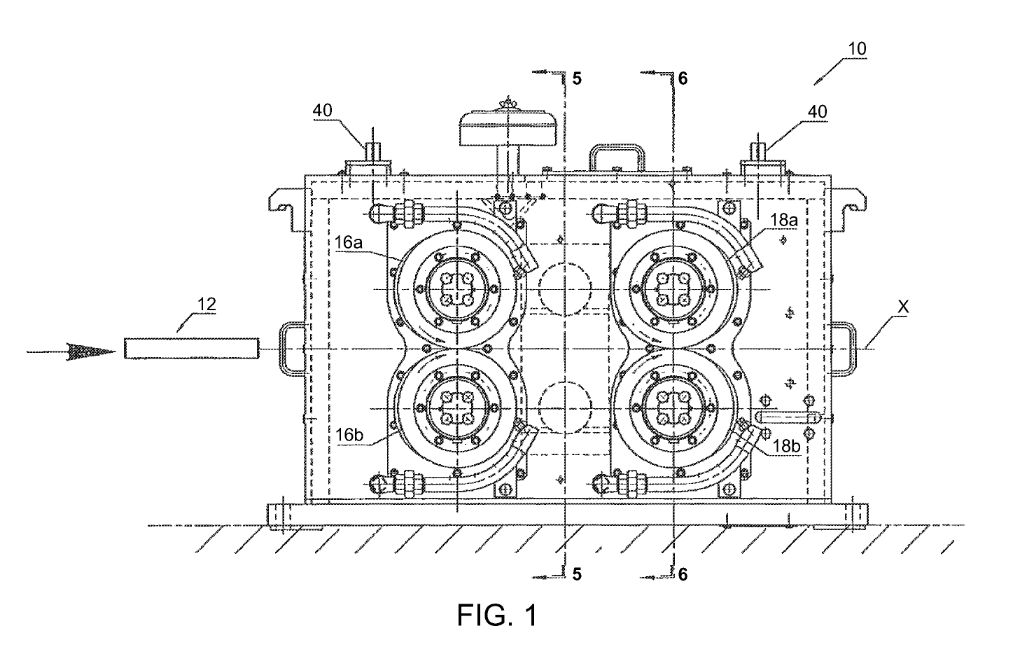

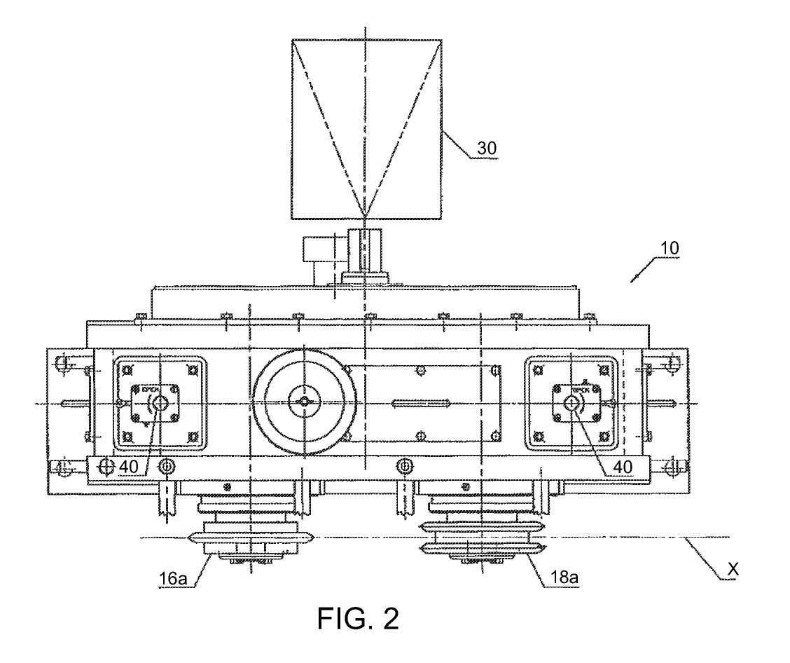

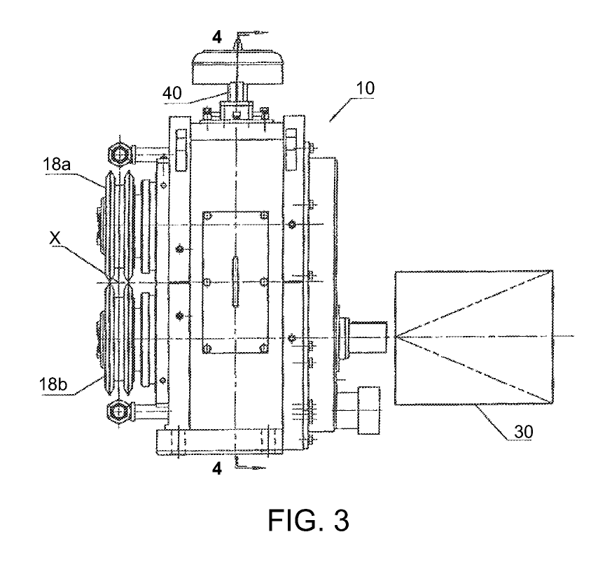

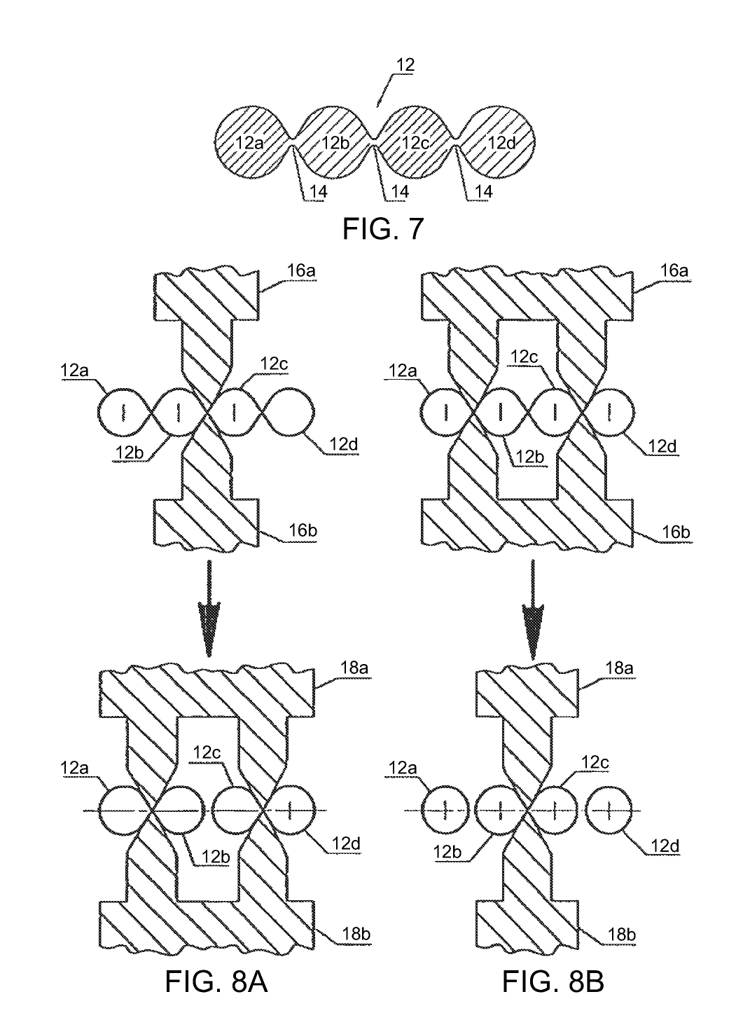

With reference initially to FIGS. 1-3, a slitting apparatus in accordance with an illustrative embodiment of the present invention is generally indicated at 10 in an operative position on the rolling line “X” of a bar mill. A process section 12 is shown moving longitudinally along the rolling line in a direction indicated by the arrow in FIG. 1. As shown in FIG. 7, the process section has multiple parallel bars 12a, 12b, 12c and 12d connected as at 14 along at least one of their lengthwise ridges.

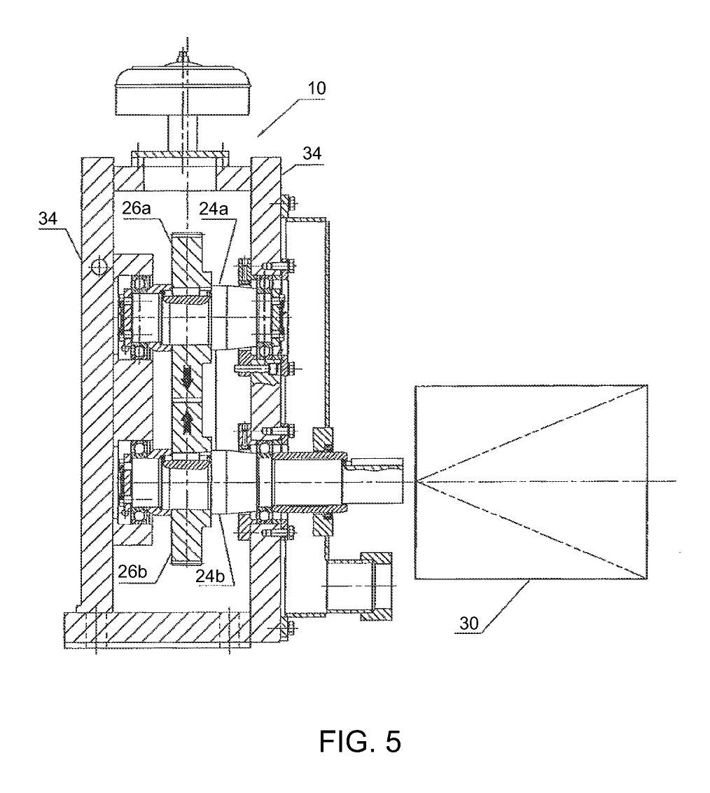

The slitting apparatus 10 comprises first and second pairs of upper and lower slitting rollers 16a, 16b and 18a, 18b positioned sequentially along the rolling line X. The slitting rollers of each pair are arranged to engage opposite sides of the process section 12 as it move longitudinally along the rolling line. In the illustrative embodiment depicted in FIGS. 1-6, the slitting rollers 16a, 16b have single slitting collars, whereas the slitting rollers 18a, 18b have dual slitting collars.

The upper and lower slitting rollers 16a, 16b of the first pair are carried respectively on upper and lower roller shafts 20a, 20b. Likewise, the upper and lower slitting rollers 18a, 18b of the second pair are carried on upper and lower roller shafts 22a, 22b.

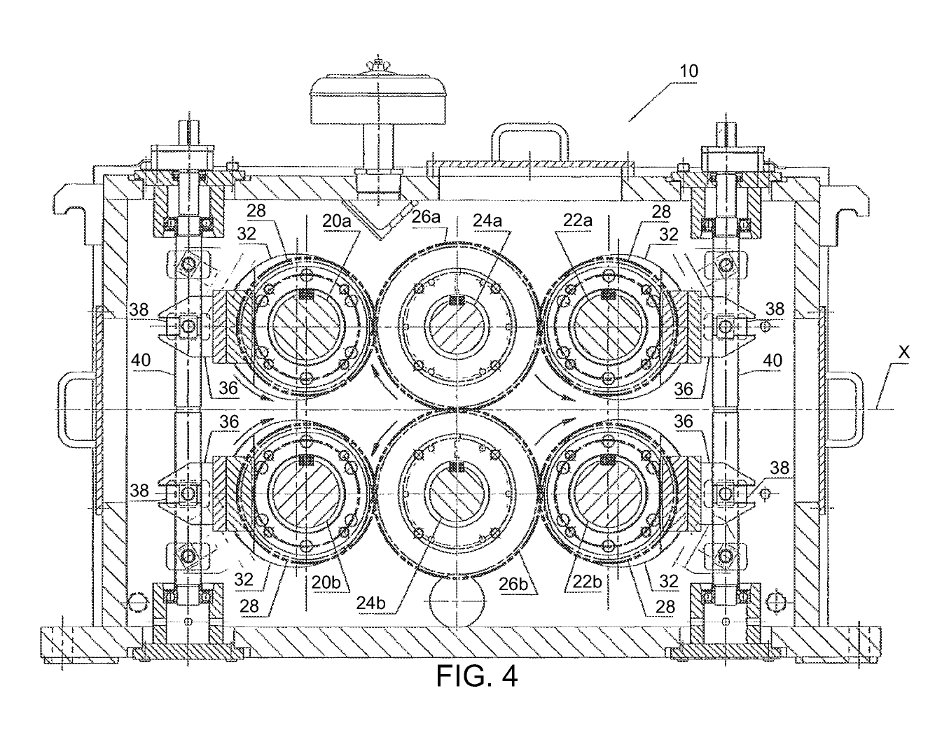

A drive means rotatably drives the slitting rollers in directions indicated diagrammatically by the arrows in FIG. 1 to thereby urge the process section 12 along the rolling line X. As can be best seen in FIGS. 4-6, the drive means comprises an upper drive shaft 24a carrying an upper drive gear 26a in meshed relationship with driven gears 28 on the upper roller shafts 20a, 22a, and lower drive shaft 24b carrying a lower drive gear 26b in meshed relationship with driven gears 28 on the lower roller shafts 20b, 22b. The upper and lower drive gears 26a, 26b are in meshed relationship, with one of the drive shafts 24b connected to a single power source 30.

Preferably, the drive means serves to rotatably drive slitting rollers at peripheral velocities that exceed the speed of the process section moving along the rolling line. Preferably, such peripheral velocities exceed the speed of the process section by about 2-3%.

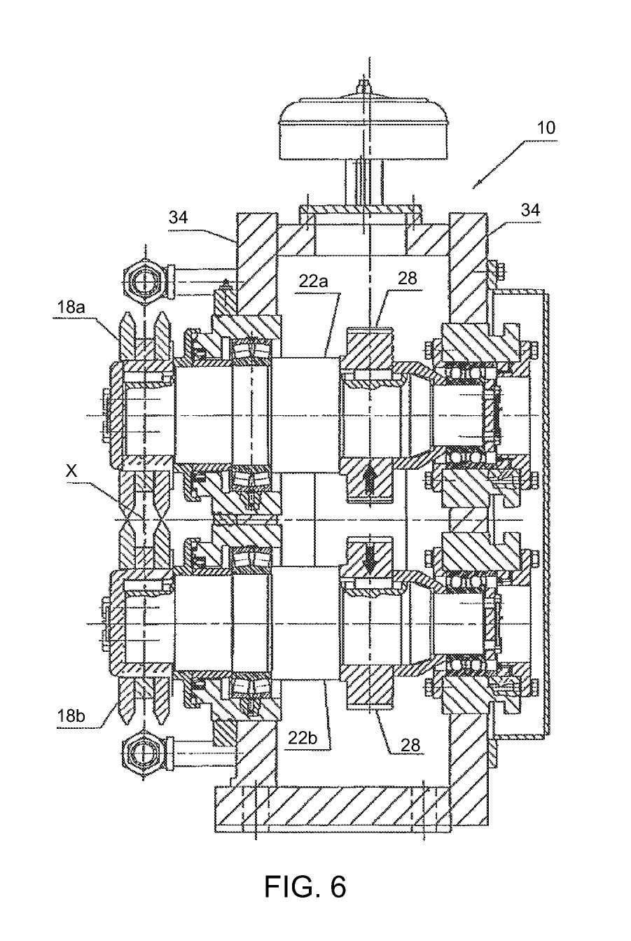

The slitting apparatus further comprises adjustment means for adjusting the spacing between the upper and lower roller shafts 20a, 20b and 22a, 22b. As can best be seen in FIGS. 4 and 6, the adjustment means comprises eccentric cartridges 32 within which the roller shafts 20a, 20b and 22a, 22b are rotatably journalled. The eccentric cartridges 32 are in turn rotatably supported in side plates 34 of the slitter housing. The eccentric cartridges 32 have radial arms 36 engaging nuts 38 threaded on opposite handthreaded sections of spindles 40. Rotation of the spindles thus serves to rotate the eccentric cartridges in opposite directions, which in turn symmetrically adjusts the spacing between the upper and lower roller shafts 20a, 20b and 22a, 22b with respect to the rolling line X.

The first pair of slitting rollers 16a, 16b have profiles configured to break the connection between at least some of the bars of the process section 12 while allowing the connections between other bars to remain intact, and the second pair of slitting rollers 18a, 18b have profiles configured to break the remaining intact connections between the other bars of the process section.

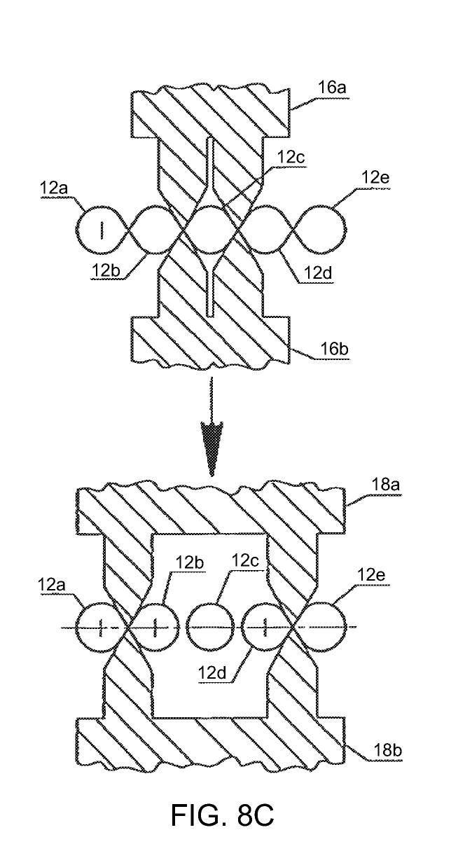

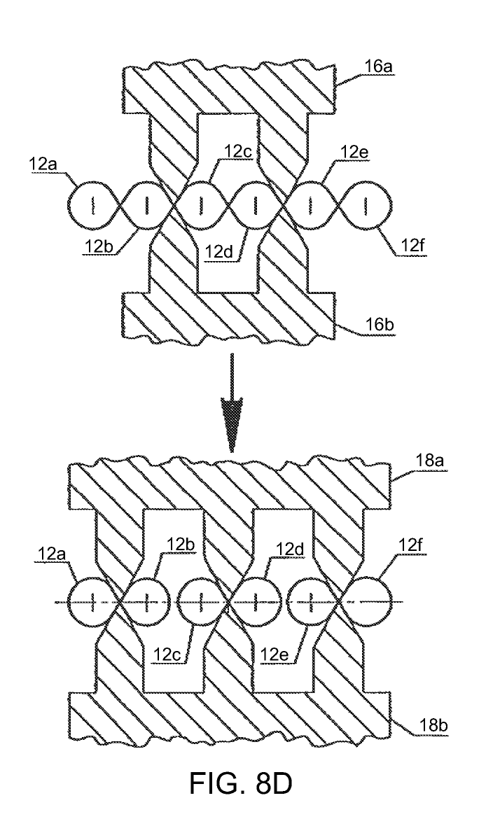

For example, and as depicted schematically in FIG. 8A, with a process section having four interconnected bars 12a-12d, the single collars of the first pair of slitting rollers 16a, 16b will separate the process section into two sets of connected bars 12a, 12b and 12c, 12d, and the second pair of slitter rollers 18a, 18b will separate the bars of each sets.

FIG. 8B illustrates a different sequence for processing a four bar process section where the first pair of slitting rollers 16a, 16b separate the outermost bars 2a, 12d on each side of the process section from the two connected middle bars 12b, 12c, and the single collars of the second pair of slitter rollers 18a, 18b separate the two connected middle bars 12b, 12c.

As shown in FIG. 8C, with a process section having five interconnected bars 12a-12e, the profiles of the first pair of slitting rollers 16a, 16b are configured to separate the middle bar 12c from the two outer sets of connected bars 12a, 12b and 12d, 12e, The second pair of slitter rollers 18a, 18b have profiles configured to separate the two bars of each outer set.

FIG. 8D illustrates a slitting sequence with a process section having six interconnected bars 12a-12f. Here, the profiles of the first pair of slitting rollers are configured to separate the process section into three sets of connected bars 12a, 12b; 12c, 12d; and 12e, 12f. The second pair of slitter rollers 18a, 18b have profiles configured to separate the bars of each set.

In each case, the rotatably driven slitting rollers serve to urge or propel the process section forwardly, thereby eliminating the need to push the process section into and through the slitter. This safeguards the bar front ends from damage, minimizes frictional wear of the slitting rollers, and allows large diameter slitting rollers to be employed, which also benefits the slitting process. Symmetrical adjustment of the roller shafts enables operating personnel to adjust for wear of the slitting rollers, and to accommodate different sizes of process section.

What is claimed is:

1. Apparatus for slitting a hot rolled process section moving longitudinally along the rolling line of a rolling mill, the process section having parallel bars connected together along at least one of their lengthwise edges, said slitting apparatus comprising:
first and second pairs of upper and lower slitting rollers positioned sequentially along the rolling line, the slitting rollers of each pair being and arranged to engage opposite sides of the process section;
drive means for rotatably driving said slitting rollers in directions urging said process section along the rolling line;
the slitting rollers of said first pair having profiles configured to break the connection between at least some of the bars of the process section while allowing the connections between other bars of the process section to remain intact; and
the slitting rollers of said second pair having profiles configured to break the remaining intact connections between the other bars of said process section.

2. The apparatus of claim 1 wherein said drive means mechanically couples the upper and lower slitting rollers of said first and second pairs to a single power source.

3. The apparatus of claim 2 wherein the upper and lower slitting rollers of said first and second pairs are carried respectively on upper and lower roller shafts, and wherein said drive means comprises an upper drive shaft carrying an upper drive gear in meshed relationship with driven gears on said upper roller shafts, and a lower drive shaft carrying a lower drive gear in meshed relationship with driven gears on said lower roller shafts, said upper and lower drive gears being in meshed relationship, with one of said drive shafts being connected to said power source.

4. The apparatus of claim 1 further comprising adjustment means for adjusting the spacing between the upper and lower roller shafts of at least one of said first and second pairs of slitting rollers.

5. The apparatus of claim 4 wherein the adjustment of said spacing is performed symmetrically with respect to the rolling line.

6. The apparatus of claim 4 wherein the upper and lower slitting rollers of said first and second pairs are carried respectively on upper and lower roller shafts, and wherein said adjustment means comprises eccentric cartridges within which said roller shafts are rotatably journalled, with means for simultaneously rotatably adjusting said eccentric cartridges in opposite directions.

7. The apparatus of claim 1 wherein the process section has four bars, wherein the profiles of the first pair of slitting rollers are configured to separate the process section into two sets of connected bars, and wherein the profiles of the second pair of slitting rollers are configured to separate the bars of each of said sets.

8. The apparatus of claim 1 wherein the process section has four bars, wherein the profiles of the first pair of slitting rollers are configured to separate the outermost bars on each side of the process section from the two middle bars, and wherein the profiles of the second pair of slitting rollers are configured to separate the two middle bars.

9. The apparatus of claim 1 wherein the process section has five bars, wherein the profiles of the first pair of slitting rollers are configured to separate the middle bar from two outer sets of two connected bars, and wherein the profiles of the second pair of slitting rollers are configured to separate the bars of each of said outer sets.

10. The apparatus of claim 1 wherein the process section has six bars, wherein the profiles of the first pair of slitting rollers are configured to separate the process section into three sets of two connected bars, and wherein the profiles of the second pair of slitti

11. The apparatus of claim 1 wherein said slitting rollers are rotatably driven at peripheral velocities that exceed the speed of the process section moving along the rolling line

12. The apparatus of claim 11 wherein the peripheral velocities of said slitting rollers exceed the speed of the process section by about 2-3%.

13. Apparatus for slitting a hot rolled process section moving longitudinally along the rolling line of a rolling mill, the process section having parallel bars connected together along at least one of their lengthwise edges, said slitting apparatus comprising:
first and second pairs of upper and lower slitting rollers carried respectively on upper and lower roller shafts and positioned sequentially along the rolling line, the slitting rollers of each pair being arranged to engage opposite sides of the process section;
drive means for rotatably driving said slitting rollers in directions urging said process section along the rolling line, said drive means comprising an upper drive shaft carrying an upper drive gear in meshed relationship with driven gears on said upper roller shafts, and a lower drive shaft carrying a lower drive gear in meshed relationship with driven gears on said lower roller shafts, said upper and lower drive gears being in meshed relationship, with one of said drive shafts being connected to a single power source;
adjustment means for adjusting the spacing between the upper and lower roller shafts of at least one of said first and second pairs of slitting rollers;
the slitting rollers of said first pair having profiles configured to break the connection between at least some of the bars of the process section while allowing the connections between other bars of the process section to remain intact; and
the slitting rollers of said second pair having profiles configured to break the remaining intact connections between the other bars of the process section.

14. A method of slitting a hot rolled process section moving longitudinally along the rolling line of a rolling mill, the process section having parallel bars connected together along at least one of their lengthwise edges, said method comprising:
directing the process section between first and second pairs of upper and lower slitting rollers positioned sequentially along the rolling line, the slitting rollers of each pair being mutually spaced and arranged to engage opposite sides of the process section; and
rotatably driving said slitting rollers in directions urging said process section along the rolling line;
the slitting rollers of said first pair having profiles configured to break the connection between at least some of the bars of the process section while allowing the connections between other bars of the process section to remain intact;
the slitting rollers of said second pair having profiles configured to break the remaining intact connections between the other bars of the process section.

15. The method of claim 14 further comprising symmetrically adjusting the spacing between upper and lower roller shafts carrying the upper and lower slitting rollers of at least one of said first and second pairs.

16. The method of claim 14 wherein the process section has four bars, wherein the profiles of the first pair of slitting rollers are configured to separate the process section into two sets of connected bars, and wherein the profiles of the second pair of slitting rollers are configured to separate the bars of each of said sets.

17. The method of claim 14 wherein the process section has four bars, wherein the profiles of the first pair of slitting rollers are configured to separate the outermost bars on each side of the process section from the two middle bars, and wherein the profiles of the second pair of slitting rollers are configured to separate the two middle bars.

18. The method of claims 14 wherein the process section has five bars, wherein the profiles of the first pair of slitting rollers are configured to separate the middle bar from two outer sets of two connected bars, and wherein the profiles of the second pair of slitting rollers are configured to separate the bars of each of said outer sets.

19. The method of claim 14 wherein the process section has six bars, wherein the profiles of the first pair of slitting rollers are configured to separate the process section into three sets of two connected bars, and wherein the profiles of the second pair of slitting rollers are configured to separate the connected bars of each of said sets.

20. The method of claim 14 further comprising adjusting the distance between the upper and lower slitting rollers of at least one of said pairs.
